(19) United States
(12) Patent Application Publication
(10) Pub. No.: US 2006/0068822 A1
(43) Pub. Date: Mar. 30, 2006

(54) Method and apparatus for implementation of ad hoc mesh network

(76) Inventor: Amit Kalhan, La Jolla, CA (US)

Correspondence Address: KYOCERA WIRELESS CORP., P.O. BOX 928289, SAN DIEGO, CA, 92192-8289, US

(21) Appl. No.: 10/954,404

(22) Filed: Sep. 29, 2004

(51) Int. Cl. H04Q 7/20

(52) U.S. Cl. 455/517

(57) ABSTRACT

By using current positions or predictions of future positions of mobile wireless communication devices, the performance of an ad hoc mesh network is improved. Current positions and predictions of future positions can be used to determine when to set up communication channels between devices. Current and future positions can be determined by the use of a Global Positioning System (GPS) Receiver or other position-determining devices. The GPS Receiver uses signals received from Satellites to determine current position, velocity and acceleration of a mobile wireless communication device. The predictions using current position, velocity and acceleration can be further improved by using devices that “know” the final destination or route of the mobile wireless communication device. An example of such a device would include, but not be limited to, automobile navigation systems that use internal maps and GPS Receivers to guide a driver to a final destination.

### FIELD

The present invention relates generally to wireless communication systems, and more particularly to ad hoc mesh networks in wireless communication systems.

### BACKGROUND

Traditionally, wireless communication networks, such as cellular networks, are developed by dividing a desired coverage area into overlapping areas. Each area is served by a base station using a point-to-multipoint (PMP) architecture. One problem with the traditional approach is the large costs associated with constructing a network. Typically these large costs are incurred before a customer base has been established to offset these costs. Traditional wireless communication networks also may be difficult to expand due to costs related to planning and coordinating the expansion. Base station resources may be limited. Additionally, more transmit power may be required when two mobile wireless communication devices communicate through a base station rather than communicating directly.

A solution to the shortcomings of traditional wireless communication networks is the use of mesh networks. In a mesh network several communication devices operate in a peer-to-peer fashion. An example of a mesh network of the prior art is shown in FIG. 11. The mesh network 600 includes several mobile communication devices 603, 607, 610, 612, 615 and a base station 620 that communicate through communication connections, such as communication connection 617. Base station 620 of mesh network 600 also is connected to a terrestrial network. As shown in FIG. 11, the mobile communication device 603 has a communication connection with mobile communication device 607. Mobile communication device 607 also is connected to mobile communication devices 610 and 612, while mobile communication devices 610 and 612 are additionally connected to each other. Mobile communication device 612 also is connected to mobile communication device 615 by communication connection 617. Finally, the mobile communication device 615 additionally is connected to the base station 620.

Each of the mobile communication devices 603, 607, 610, 612, 615 and the base station 620 have the ability to relay communication signals between an originating device and a final destination. As an example, assume that mobile communication device 603 is sending a message to mobile communication device 615. Mobile communication device 603 can transmit to mobile communication device 607. Mobile communication device 607 can transmit to mobile communication device 612. Finally, mobile communication device 612 can transmit to mobile communication device 615 to complete the sending of the message between mobile communication device 603 and 615. If the message discussed above must be sent over the terrestrial network, then mobile communication device 615 can transmit the message to the base station 620, and the base station 620 can transmit the message to the terrestrial network.

Not all mesh networks include a base station 620. In some cases the mesh network may be used to communicate solely between mobile communication devices, Additionally, in some cases, mesh networks may be set up between communication devices that are not mobile. The example shown in FIG. 11 is only one possible example. A mesh network has many advantages. For example, a mesh network can alleviate problems associated with the economic burden of setting up a PMP. Also, mesh networks are typically easier to expand by simply adding more devices. The addition of more devices may have the advantage of creating more communications paths, such as the communication path 617 shown in FIG. 11. However, some mesh networks may have a maximum number of communication devices allowed.

In some applications of a mesh network, the network capacity can be increased. Specifically, lower power typically is required to communicate between multiple devices as compared to the power required when the same multiple devices must communicate through a base station. Thus, direct communication between devices requires lower power to transmit, which may lead to more devices being able to share scarce bandwidth resources.

While mesh networks have several advantages, mesh networks also present limitations for use. For example, relaying devices within a mesh network are forced to delay any desired communication while relaying the communication of other parties. In many cases the relaying devices only have a single transceiver. The transceiver may, in some cases, not be available to send and receive other communications when it is being used to relay a first communication signal. Thus, it would be advantageous to more efficiently use the limited number of transceivers in mobile communication devices.

Power is a limited resource, particularly on mobile wireless devices that use battery power to function. Inefficient use of transmit power can lead to lower talk time or increase in interference with other users of the mesh network, or both. In many cases it may be more efficient to transmit directly between two mobile communication devices than to use a base station or multiple base stations to facilitate the transmission. Specifically, if the two mobile communication devices are close together it may be more power efficient for the devices to communicate directly. Thus, for more efficient mesh network operation, it would be advantageous to determine a way to accurately predict when communication devices can communicate directly.

In an mesh network it may be difficult to determine what communication devices are available for communication. Mesh networks may also be difficult to keep active in areas that have few communication devices. Additionally, using a large number of “hops” to allow users to communicate is inefficient. It would be advantageous to find a way to predict what devices are available for communication, accurately predict future device connections, and use predictions to minimize the number of “hops” in a network.

### SUMMARY

The use of point-to-multipoint (PMP) communication systems typically has a significant economic burden associated with deploying the system. The costs of setting up base stations can, in some cases, be prohibitively expensive. In situation where the costs are not prohibitively expensive, another possible problem is that expenses related to setting up the network may occur before revenue is being generated from customers' use of the network. One way that has been proposed to solve these problems is the use of mesh networks. In a mesh network a number of communication devices operate in an peer to peer “ad hoc” fashion. Links between the communication devices are established where possible between communication devices and communication messages can be relayed from one communication device to another.

The use of mesh networks does however have some problems. For example, when one or more communication devices are used to relay a communication message between two devices in the mesh network, the relaying units within a mesh network are forced to delay any desired communication while relaying the communication of other parties.

By using current position or a prediction of future position, the performance of an ad hoc mesh network may be improved in many cases. Current position and predictions of future position can be used to determine when to set up a communication channel between devices. Additionally, current position and predictions of future position can be used to determine what devices to set up communication channels with to provide a path between multiple communication devices that desire to communicate. Position can be determined by the use of a Global Positioning System (GPS) receiver. The GPS receiver uses signals received from satellites to determine position. While GPS receivers are a common device used to determine position, other devices are possible. GPS receivers can generally also determine velocity and acceleration. Velocity and acceleration can be used to predict future position. The prediction can be used to determine when to set up communication channels between communication devices. The use of the prediction can be further improved when using devices that “know” the final destination. An example of such a device would include, but not be limited to, automobile navigation systems that use internal maps and GPS receivers to guide a driver to a final destination. The future location of a communication device may be more accurately predicted when the final destination and route traveled are known in addition to the velocity and the acceleration of a communication device.

The use of future location prediction can help to solve problems associated with movement of communication devices within the network. If two devices are predicted to be within range of each other in the future, in some cases communication between the two devices can be delayed until they can communicate with each other directly. By delaying the communication, the need for a relay communication device is eliminated. In some cases, interference between devices can be lowered by lowering the transmit power of transmitting devices. In these cases it may make sense to use a relay device so that transmit power can be lowered. Alternatively, when two communication devices are predicted to be closer together at a future time it may make sense to wait until devices are closer together so that transmit power can be lowered. This same idea can be extended to include more than two devices. As an example, if the current and future locations of three communication devices are known it may be possible to predict the best time for the devices to communicate. By using position information and predictions of future position the number of relay devices may be decreased in some cases. Additionally, in cases where transmit power is lowered, talk time and standby time would typically be increased.

### BRIEF DESCRIPTION OF THE DRAWINGS

For a more complete understanding of the present invention, and the advantages thereof, reference is now made to the following descriptions taken in conjunction with the accompanying drawings, tables and attachments, in which:

FIG. 1 illustrates multiple mobile wireless communication devices in ad hoc networks.

FIG. 2 shows a mobile wireless communication device.

FIG. 3A illustrates multiple mobile wireless communication devices in an ad hoc network in a series of first positions.

FIG. 3B illustrates multiple mobile wireless communication devices in an ad hoc network in a series of second positions.

FIG. 4 shows a mobile wireless communication device with multiple transmit power settings.

FIG. 5 illustrates two mobile wireless communication devices that are generally moving towards each other.

FIG. 6 shows three mobile wireless communication devices with two transmit power settings.

FIG. 7 illustrates a mobile wireless communication device that can transmit directionally.

FIG. 8 shows two mobile wireless communication devices that each have different transmit power levels.

FIG. 9 illustrates two mobile wireless communication devices traveling along predetermined paths to predetermined destinations.

FIG. 10 is a block diagram of a mobile wireless communication device.

FIG. 11 is a diagram of an ad hoc network of the prior art.

### DETAILED DESCRIPTION

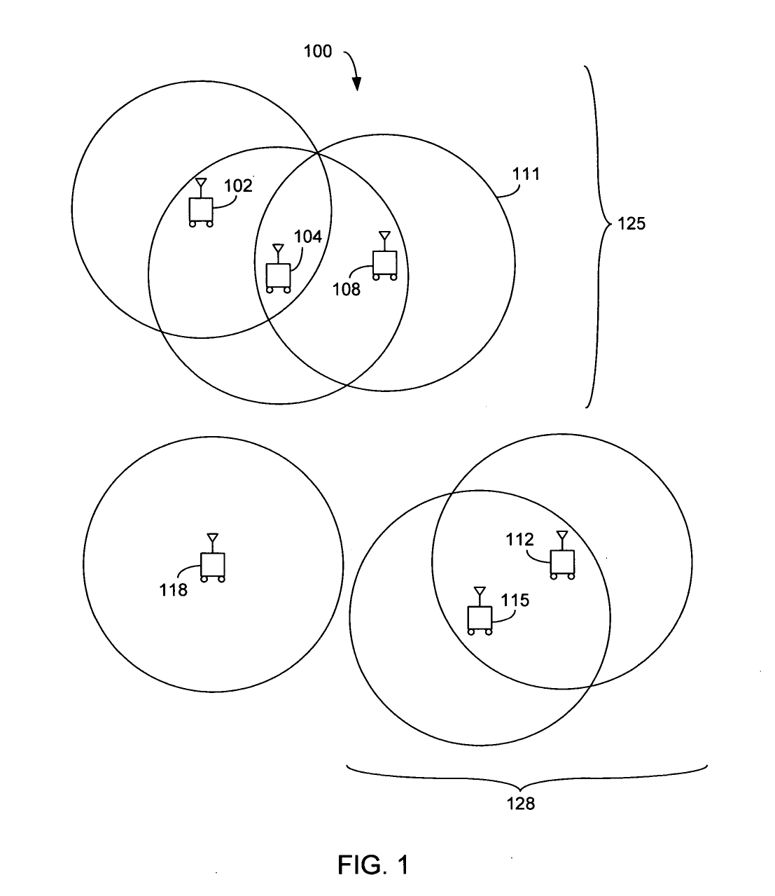

FIG. 1 illustrates multiple mobile wireless communication devices 102, 104, 108, 112, 115, 118 of a communication network 100. Each of the multiple mobile wireless communication devices 102, 104, 108, 112, 115, 118 is shown enclosed by a circle. As an example, a circle 111 encloses the mobile wireless communication device 108. The circle 111 represents an area within which a mobile wireless communication device can communicate. When another mobile wireless communication device, e.g., device 104 is within the circle 11, the mobile wireless communication devices 108, 104 can communicate with each other. Specifically, the circle represents the distance that the transmission of the mobile wireless communication device can be received. This will be discussed further with respect to FIG. 2.

The communication network 100 include a first ad hoc network 125 and a second ad hoc network 128. The first ad hoc network 125 includes mobile wireless communication devices 102, 104, 108. The second ad hoc network includes mobile wireless communication devices 112, 115. The mobile wireless communication device 118 is not part of an ad hoc network.

In the first ad hoc network 125, each of the mobile wireless communication devices 102, 104, 108 can communicate with each other. Mobile wireless communication device 102 can communicate directly with mobile wireless communication device 104. Mobile wireless communication device 104 can communicate directly with mobile wireless communication device 108. Mobile wireless communication devices 102 and 108 can communicate indirectly by using mobile wireless communication device 104. The second ad hoc network 128 contains two mobile wireless communication devices 112 and 115. Each of the mobile wireless communication devices can communicate with each other.

By using velocity and location information, determined, for example, using global positioning system (GPS) receivers, predictions can be made to determine what mobile wireless communication devices can communicate now and at some future time. The mobile wireless communication devices 102, 104, 108, 112, 115, 118 shown on the diagram 100 typically are moving. The constantly changing position of the communication devices results in dynamic ad hoc networks. That is, the specific devices in an ad hoc network may change, and an ad hoc network may cease to exist while a new ad hoc network may be created.

The use of location and velocity information in conjunction with an ad hoc network provides an ability to use mobile wireless communication device resources more efficiently. For example, when two devices that need to communicate are predicted to be within range of each other in the future, in some cases the communication between the devices can be delayed until the devices can communicate directly, eliminating the need for a relay communication device.

Referring now to FIG. 2, a mobile wireless communication device 153 is shown within a circle 156. The mobile wireless communication device 153 is the same or similar to the mobile wireless communication devices 102, 104, 108, 112, 115, 118 as shown in FIG. 1. Similarly, the circle 156 is the same or similar to the circle 111 shown in FIG. 1. It will be clear to one of skill in the art that by saying that the circles are the same or similar it is meant that the circles represent the same or similar concepts. Specifically, the circle 156 represents the distance that a mobile wireless communication device 153 can transmit a communication signal. This circle may also be referred to as a communication area or a coverage area of a mobile wireless communication device.

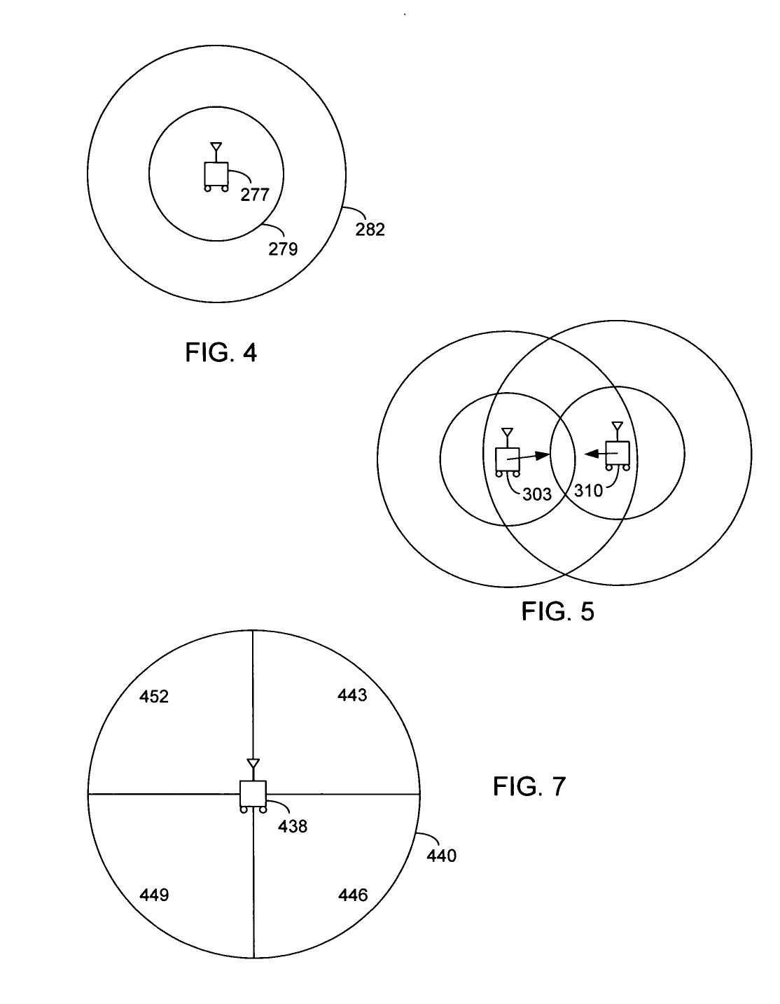

It is important to note that the circle 156 is only intended to be an example. The actual shape of the area may vary due to geographic features such as hills that may block a transmission. Other geographic features such as valleys and buildings may change the shape of the area. In many cases the area will not be a circle. Additionally, the area may vary based on the receiver. Some receivers may be able to receive a signal from farther away than others. The circle 156 is only intended to pictorially display a concept. Specifically, mobile wireless communication device transmissions typically can be received over a finite area. That area may vary based on several factors, such as, for example transmit power, geographic features, properties of the transmitter, properties of the receiver, as well as other factors. Differences in transmit power will be discussed further with respect to FIG. 4. Advantages of using a predictive ad hoc network may include, in some cases, lower interference with other communication devices due to the lower transmit power that may be used when device communications are delayed until times when the devices are predicted to be closer together.

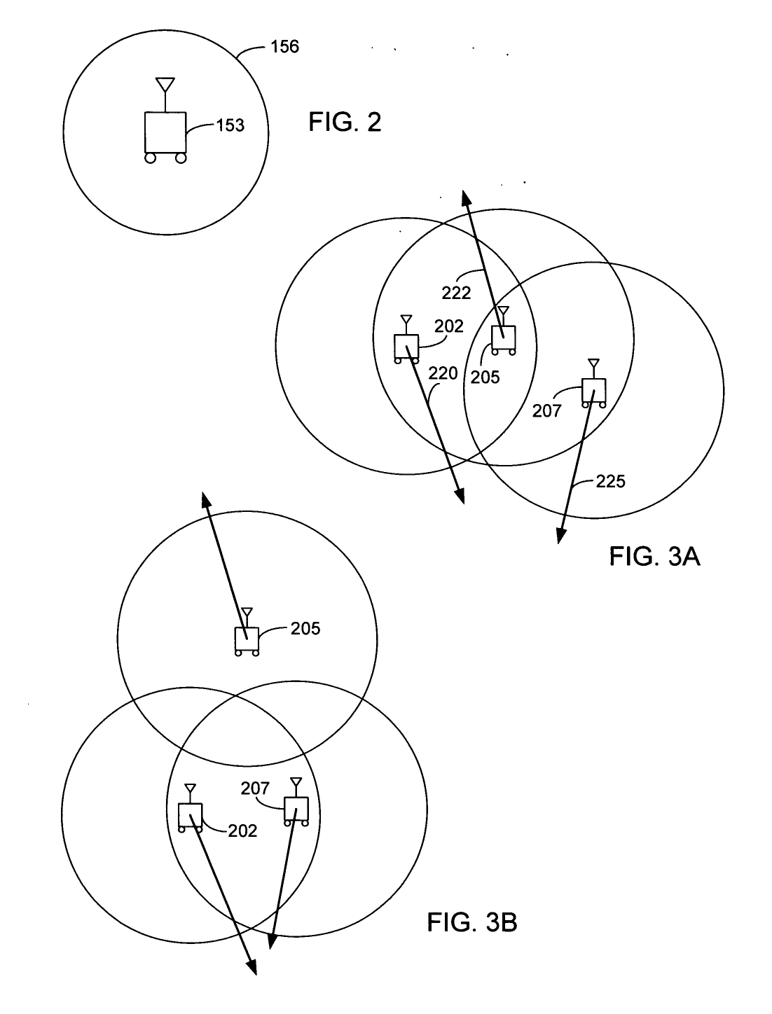

FIG. 3A illustrates mobile wireless communication devices 202, 205, 207 in an ad hoc network. The mobile wireless communication devices 202, 205, and 207 are the same or similar to the mobile wireless communication devices 102, 104, 108, 112, 115, and 188 shown in FIG. 1. Additionally, the mobile wireless communication devices 202, 205, and 207 are the same or similar to the mobile wireless device 153 of FIG. 2. The mobile wireless communication devices 202, 205, 207 are shown moving, as indicated by the arrows 220, 222, and 225. The movement of each device 202, 205, 207 is further indicated by the change in position shown in FIG. 3B. In FIG. 3A, mobile communication device 202 is not able to communicate directly with mobile communication device 207. However, it can be predicted that the device 202 and device 207 may be able to communicate directly at a later time as shown in FIG. 3B. As predicted the devices 202 and 207 can communicate directly.

FIG. 4 illustrates a mobile wireless device 277 that is enclosed in a first circle 279 and a second circle 282. The first circle 279 indicates a first transmit range, and the second circle 282 indicates a second transmit range. Typically the range of a mobile wireless device may be changed by increasing or decreasing transmit power. Although, FIG. 4 shows a mobile wireless device 277 with two transmit power levels, typically mobile wireless communication devices have more than two transmit power level settings. The coverage areas corresponding to two transmit power level setting are shown in FIG. 4 in a simplified example.

While the transmit range of the mobile wireless device 277 typically is effected by transmit power, other factors can have an effect on range. As an example, the type of antenna on the receiving mobile wireless device may change the receiving mobile wireless device's ability to receive a signal transmitted from the transmitting mobile wireless device. The circles are used to generally describe the concept that mobile wireless communication devices have some finite range, however, that range is effected by many factors, including transmit power, and geography of the area, as well as other factors.

Advantages of using location to predict ad hoc networks may, in some cases include, the ability to save battery power by predicting a future time when a lower power transmission can be used, and the improvement in overall communication efficiency. It should be noted that while the term “battery power” is used, other forms of mobile power source, such as fuel cells, may be possible. In some cases, increased efficiency may be due to a decrease in interference with other users of a mesh network. The prediction discussed above will be discussed further below with respect to FIG. 5.

FIG. 5 shows two mobile wireless communication devices 303 and 310. The mobile wireless communication devices 303 and 310 are generally moving towards each other. As shown in the figure, the mobile wireless devices 303 and 310 can communicate using the high transmit power setting. It can be seen from the diagram 300 that if the mobile wireless communication devices 303 and 310 continue to move towards each other as shown on the figure the mobile wireless communication devices 303 and 310 will be able to communicate using the low power setting at some future point in time.

In some situations, it may be advantageous to wait until the future point in time to transmit at the lower power setting. Several factors may be considered when determining whether a mobile transmission should be delayed. Some of these factors may include, the speed at which the mobile devices are approaching each other, how time critical the message to be transmitted is, and the probability that the prediction will be accurate. Several factors, or combinations of factors can be weighed to determine when to transmit a message. It will be understood that in some cases the directions of travel of the mobile wireless communication devices may change before the devices are close enough to use the low power settings.

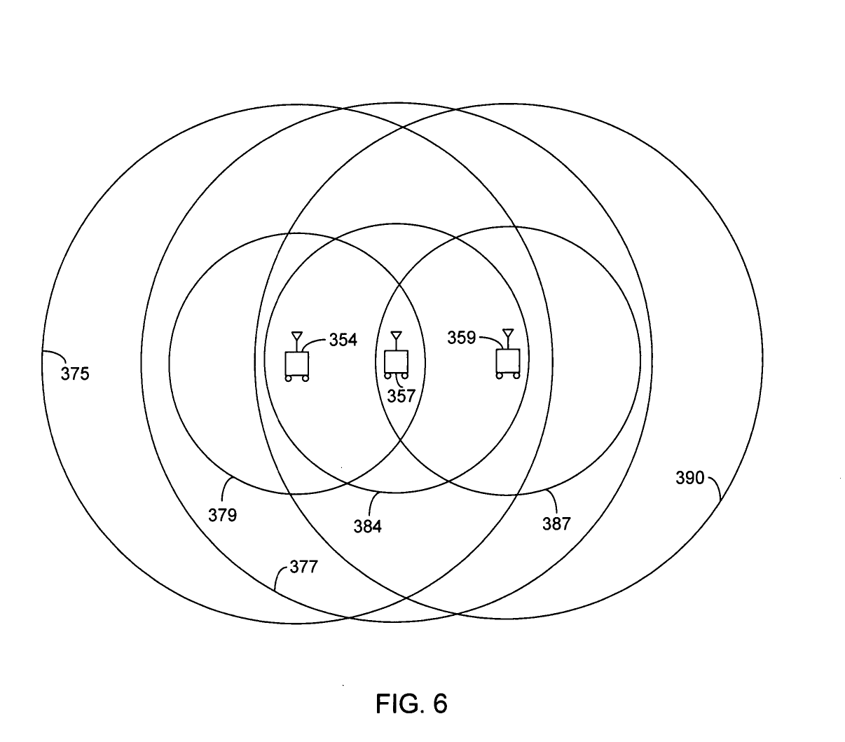

Referring now to FIG. 6, three mobile wireless communication devices 354, 357, and 359 include two power settings each as indicated by the circles 375, 377, 379, 384, 387 and 390. As can be seen in FIG. 6, the mobile wireless device 354 can communicate directly with mobile wireless device 359 when the two mobile wireless communication devices transmit at the high transmit power level, shown by the circles 375 and 390. Alternatively, by using the mobile wireless device 357, the mobile wireless communication devices 354 and 359 can communicate while transmitting at the low power level, as indicated by the circles 379, 384 and 387.

In some cases it may be advantageous to transmit at the lower power level. Transmitting at the low power level may typically save battery power on the mobile wireless communication devices 354 and 359, and in some cases, transmitting at lower power may decrease interference with other communication devices. Additionally, the mobile wireless communication devices 354 and 359 may cause less interference with other electronic transmissions when transmitting at lower power. When devices 354 and 359 are transmitting at the higher transmit power level, however, the mobile wireless device 357 may use less battery power. Additionally, the mobile wireless device 357 may be able to use its transmit and receive circuits to send and receive other transmissions.

FIG. 7 shows a mobile wireless device 438 within a circle 440. The circle generally indicates the transmit range of the mobile wireless device 438. However, the transmit range may be some shape other than a circle, and may vary in range based on many factors including geography, transmit power, transmit antenna type, and receive antenna type. The mobile wireless device 438 is able to send directional transmissions. As shown in FIG. 7, the mobile wireless device 438 can transmit in four different directions 443, 446, 449, 452. By using a directional antenna the mobile wireless device can transmit to specific mobile wireless communication devices, and can limit the amount of interference it causes to other mobile wireless communication devices. As an example, assume that a mobile wireless device is in the area 443, and other mobile wireless devices are in area 446, 449 and 452. The mobile wireless device 438 can transmit to the mobile wireless device in area 443 while not transmitting to any of the other areas 446, 449, 452 which may cause interference.

FIG. 7 is a simplification of a mobile wireless device including a directional antenna. While four different directions 443, 446, 449, 452 are shown, systems that have more directions of transmissions, or fewer directions are possible. Additionally it will be understood that electronic transmission devices that include directional antennas are generally known and understood. It is not the purpose of this application to describe any specific method or device that is capable of transmitting using a directional antenna, or any other method of transmitting directionally. The direction to transmit in using a mobile wireless device can, however, be predicted using the devices and methods described.

While the mobile wireless device 438 is shown as having a directional antenna, this is only one possible example. Both transmitting communication devices and receiving communication devices may benefit from a directional antenna. Additionally, in some cases a wireless device or devices in a wireless communication system may not be mobile wireless communication devices. The figures are possible examples, and other examples will be understood by those of skill in the art.

Referring now to FIG. 8, a first mobile communication device 472 and a second mobile communication device 474 are shown enclosed in a first circle 467 and a second circle 469, respectively. In some cases a first mobile communication device 472 may be able to receive a transmission from a second mobile communication device 474 while the second mobile communication device 474 may not be able to receive a transmission from the first mobile communication device 472. For example, the second mobile communication device 474 may be able to transmit using more transmit power than the first mobile communication device 472, as shown in FIG. 8. The first circle 467 is shown as a smaller circle than the second circle 469.

The size of the circle, as described with respect to FIGS. 4, 5, 6, and 8 generally shows range of the mobile wireless device. The circle may be indicative of transmit power as described, however, other factors may effect the range of the mobile wireless devices. Additionally, the range of the mobile wireless communication devices may be a function of multiple factors. Other factors that may effect the range of a mobile wireless device include, but are not limited, to the geography of the local area, the transmit antenna of the transmitting device, and the receiving antenna of the receiving device. Although a circles 467, 469 are illustrated, the shapes of the coverage areas 467, 469 may vary in different direction due to geographic features, including hills, valleys, and buildings. The circles used in the figures are only intended to help describe a the concept that mobile wireless communication devices transmissions can typically only be received over background noise over some finite range, and within some finite area.

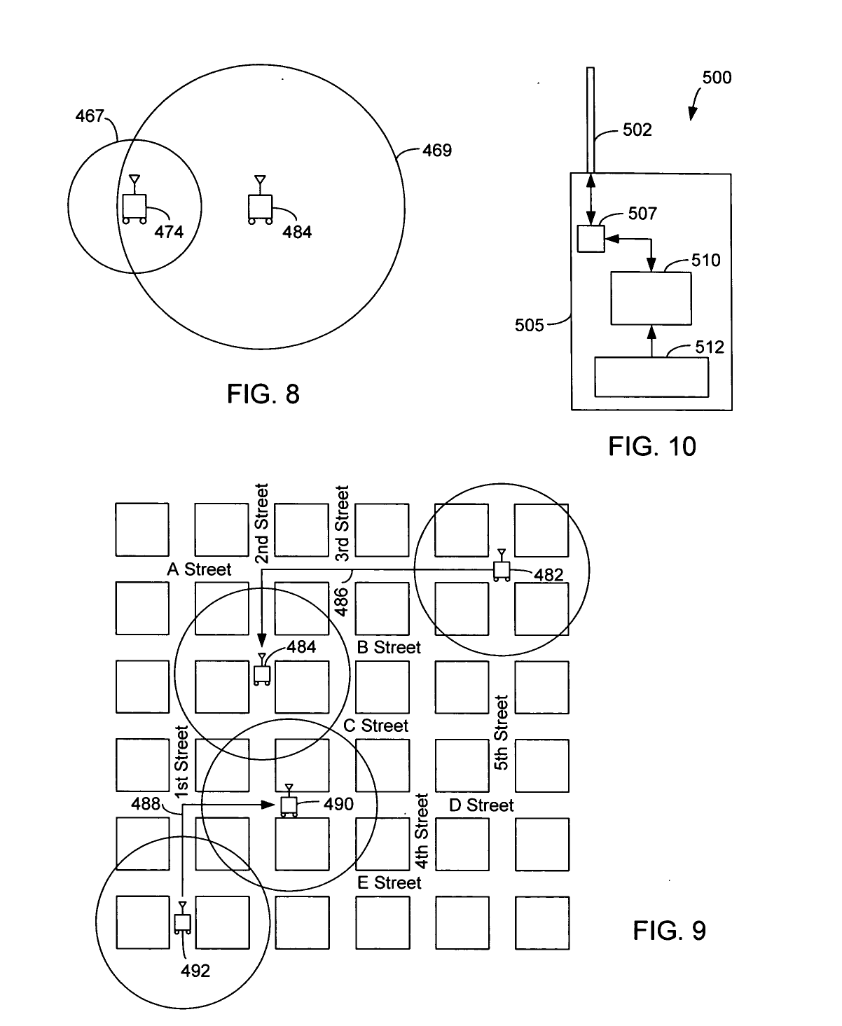

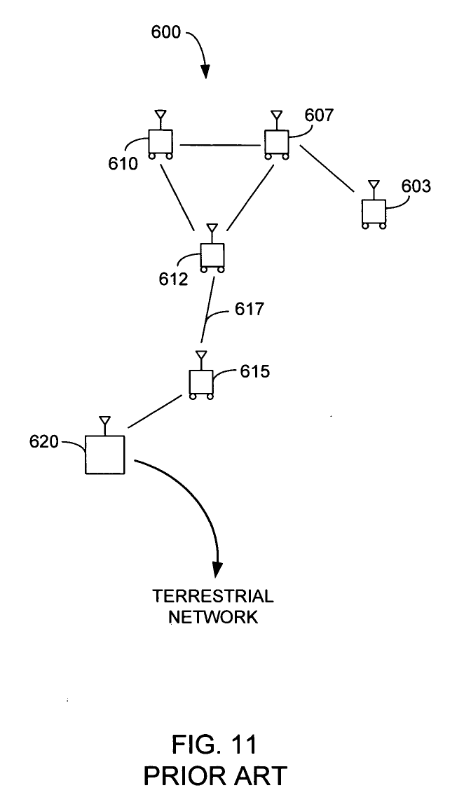

FIG. 9 illustrates two mobile wireless communication devices traveling along predetermined paths to predetermined destinations. Many automobiles, especially newer automobiles, include a navigation system that assists the driver in finding a location, such as an address. These navigation systems typically use GPS satellites to determine location, and have internal mapping capabilities that determine a path of travel to a desired location. Many systems are built into automobiles, however, handheld systems are possible. Additionally, navigation systems can be built into other types of vehicles. It will be clear to those of skill in the art that the specific type of navigation system and the specific implementation may vary. Information from the navigation system can be used to predict when two mobile communication systems will be able to communicate.

FIG. 9 shows a mobile communication device in a first location 482. The mobile communication device travels along a first predetermined path 486 to a second location 484. A second mobile communication device travels from a third location 492 along a second predetermined path 488 to a fourth location 490. As can be seen in FIG. 9, when the first mobile communication device is in location 484 and the second mobile communication device is in location 490, the mobile wireless communication devices may be able to communicate. Navigation systems typically estimate when a vehicle will arrive at a location. If the mobile wireless communication devices arrive at locations 484 and 490 at the same or similar times the devices may be able to communicate. Locations 484 and 490 may be final destinations, however, in other scenarios, the locations 484 and 490 could also be interim locations along longer paths of travel. It will be clear to those of skill in the art the mobile wireless communication devices may not stop at locations 484 and 490. Additionally, the mobile wireless communication devices may be able to communicate at other locations along the path of travel.

The navigation system, or some part of the navigation system may be part of the mobile communication device. As an example, the mobile communication device may include a GPS receiver and a circuit to determine location based on the GPS signals. The device may also include a map display and software to determine a path of travel to a location. Advantages may, in some cases include improved predictions of future locations by using navigation information.

Referring now to FIG. 10, a mobile handset 500 will be discussed. The mobile handset 500 includes an antenna 502. The antenna, 502 is shown external as an external antenna, however, other configurations are possible. The antenna 502 may be an internal antenna. Additionally, the antenna 502 may be multiple antennas.

The handset also includes a transceiver 507. The transceiver 507 is coupled to a processor 510. The processor 510 may be a mobile station modem (MSM), a processor, microprocessor, or microcontroller. Additionally, the processor 510 may be circuitry, such as discrete logic, or programmable logic device, such as a field programmable logic device (FPGA), or complex logic device (CPLD). The processor 510 is coupled to a mobile power source 512. The mobile power source 512 may be a battery or a fuel cell, additionally, other power sources are possible. FIG. 10 shows the mobile power source 512, processor 510, and transceiver 507 enclosed in a case 505. It will be understood, however, that the components that are enclosed in the case 505 may vary.

FIG. 10 is one possible example of a mobile communication device, however, other examples are possible. Advantages may include improved network performance. The improvement may occur when lower transmit power can be used, potentially allowing more mobile wireless communication devices to operate in a given geographic area.

Generally figures in this application are not drawn to scale and no scale should be implied. Additionally, while the FIGS. 1 -10 show mobile wireless communication devices, it will be clear to one of skill in the art that in some cases one ore more base stations, or fixed wireless devices may be included. The scope of the invention is only limited by the claims.

What is claimed is:

1. A method of communicating between mobile wireless communication devices comprising the steps of:
acquiring a position of a first mobile wireless communication device;
acquiring a position of a second mobile wireless communication device;
predicting if the first mobile wireless communication device can communicate with the second mobile wireless communication device based on position; and
transmitting a communication signal between the first mobile wireless communication device and the second mobile wireless communication device.

2. The method of claim 1 wherein the first mobile wireless communication device determines the position of the second mobile wireless communication device from another communication device.

3. The method of claim 2 wherein the another communication device is a third mobile wireless communication device.

4. The method of claim 2 wherein the another communication device is a base station.

5. The method of claim 1 wherein the transmitting step includes transmitting in a direction.

6. The method of claim 5 wherein the transmitting in a direction includes using a directional antenna.

7. The method of claim 1 wherein the predicting step includes using a navigation device.

8. The method of claim 1 wherein the predicting step includes determining that the first and second mobile wireless communication devices can communicate by transmitting to at least one additional mobile wireless device.

9. The method of claim 8 wherein it is predicted that the first and second mobile wireless communication devices may be able to communicate directly at another time.

10. The method of claim 9 wherein communication between the first mobile wireless communication device and the second mobile wireless communication device occurs at the another time.

11. The method of claim 1 wherein the predicting step includes determining that the first mobile wireless communication device and the second mobile wireless communication device can communicate by transmitting at a high power setting.

12. The method of claim 11 wherein it is also predicted that the first mobile wireless communication device and the second mobile wireless communication device will be able to communicate at another time using a low transmit power.

13. The method of claim 12 wherein the first mobile wireless communication device and the second mobile wireless communication device communicate at the another time at the low transmit power.

14. A method of communicating between mobile wireless communication devices comprising the steps of:
acquiring a first position of a first mobile wireless communication device;
acquiring a second position of a second mobile wireless communication device;
acquiring a third position of a third mobile wireless communication device;
predicting that the first mobile wireless communication device can communicate with the second mobile wireless communication device based on the first position and the second position;
predicting that the second mobile wireless communication device can communicate with the third mobile wireless device based on the second position and the third position;
determining that the first mobile wireless communication device can communicate with the third mobile wireless communication device by using the second mobile wireless communication device as an intermediary; and
transmitting a communication signal between the first mobile wireless communication device and the third mobile wireless communication device.

15. The method of claim 14 further comprising the steps of:
acquiring a first velocity of a first mobile wireless communication device;
acquiring a second velocity of a second mobile wireless communication device; and
acquiring a third velocity of a third mobile wireless communication device;
wherein the prediction steps are further based on the first velocity, the second velocity and the third velocity.

16. A mobile wireless communication device comprising:
a processor for performing the following steps:
determining a first location of the mobile wireless communication device;
determining a second location of a second mobile wireless communication device; and
predicting, based on the first location and the second location, that the mobile wireless communication device can communicate with the second mobile wireless communication device;
an antenna;
a transceiver connected to the antenna and to the processor;
a mobile power source configured to power the transceiver and the processor; and
a case enclosing the processor, the transceiver and the mobile power source.

17. The mobile wireless communication device of claim 16 wherein the processor performs the additional steps of:
predicting that the mobile wireless communication device may be able to communicate with the second mobile wireless communication device using a high transmit power level at a determined time; and
causing the transceiver to transmit to the second mobile wireless communication device at the determined time.

18. The mobile wireless communication device of claim 16 wherein the processor performs the additional steps of:
predicting that the mobile wireless communication device may be able to communicate with the second mobile wireless communication device using a low transmit power level at a determined time; and
causing the transceiver to transmit to the second mobile wireless communication device at the determined time.

19. The mobile wireless communication device of claim 16 wherein the processor performs the additional steps of:
predicting that the mobile wireless communication device may be able to communicate with the second mobile wireless communication device by transmitting in a specific direction; and
causing the transceiver to transmit to the second mobile wireless communication device in the specific direction.

20. The mobile wireless communication device of claim 16 wherein the processor performs the additional steps of:
predicting that the mobile wireless communication device may be able to communicate with the second mobile wireless communication device at a determined time using information from a navigation device; and
causing the transceiver to transmit to the second mobile wireless communication device at the determined time.

21. The mobile wireless communication device of claim 20 wherein the navigation device is internal to the mobile wireless communication device

22. The mobile wireless communication device of claim 16 wherein the processor performs the additional steps of:
predicting that the mobile wireless communication device may be able to communicate with the second mobile wireless communication device using a low transmit power level at a determined time by communicating through at least one additional mobile wireless communication device; and
causing the transceiver to transmit at low power to the second mobile wireless communication device at the determined time through the at least one additional mobile wireless communication device.

23. The mobile wireless communication device of claim 16 wherein the processor performs the additional steps of:
predicting that the mobile wireless communication device may be able to communicate with the second mobile wireless communication device using a low transmit power level at a determined time by communicating through at least one additional mobile wireless communication device;
predicting that the mobile wireless communication device may be able to communicate with the second mobile wireless communication device using a high transmit power level at the determined time; and
causing the transceiver to transmit at high power to the second mobile wireless communication device at the determined time without using the at least one additional mobile wireless communication device.

24. A wireless communication device comprising:
a processor for perform the following steps:
determining a first location of the wireless communication device;
determining a first velocity of the wireless communication device;
determining a second location of a second wireless communication device;
determine a second velocity of the second wireless communication device; and
predicting, based on the first location, the second location, the first velocity and the second velocity, that the wireless communication device can communicate with the second wireless communication device;
an antenna;
a transceiver connected to the antenna and to the processor; and
a mobile power source configured to power the transceiver.

25. The wireless communication device of claim 24 wherein the step of predicting is a prediction that the first wireless communication device will be able to communicate with the second wireless communication device at a future time.

26. A mobile wireless communication device for use in a mesh network comprising:
a location determination device for determining a location of a first wireless communication device and a second wireless communication device in the mesh network;
a directional antenna system for receiving a signal from the first mobile wireless communication device according to a local predetermined pattern of a plurality of directions, the signal arriving from a first direction of the plurality of directions;
a receiver connected to the directional antenna system;
a transmitter connected to the directional antenna system;
a controller connected to the receiver, the transmitter, the directional antenna system, and the location determination device, the controller for controlling the directional antenna system, the controller interrupting the local predetermined pattern and cooperatively controlling the transmitter and the directional antenna to send a second signal to the second wireless communication device in a selected second direction of the plurality of directions, the selected second direction based upon the location of the second mobile wireless communication device.

27. The mobile wireless communication device of claim 26 wherein the directional antenna system is a steered beam antenna system.

28. The mobile wireless communication device of claim 26 wherein the directional antenna system is an antenna system having a plurality of sectors.

29. The mobile wireless communication device of claim 28 wherein the plurality of sectors is six sectors.
